(19) United States
(12) Patent Application Publication
(10) Pub. No.: US 2014/0173577 A1
(43) Pub. Date: Jun. 19, 2014

(54) PATCHLESS UPDATE MANAGEMENT ON MOBILE DEVICES

(71) Applicant: ASURION, LLC, (US)

(72) Inventors: Josh Mitchell, San Antonio, TX (US); Shawn O'Donnell, Long Beach, CA (US)

(73) Assignee: ASURION, LLC, Nashville, TN (US)

(21) Appl. No.: 13/843,775

(22) Filed: Mar. 15, 2013

Related U.S. Application Data
(60) Provisional application No. 61/739,640, filed on Dec. 19, 2012.

(51) Int. Cl. G06F 9/445

(52) U.S. Cl. CPC G06F 8/67
USPC 717/168

(57) ABSTRACT

Technologies for mobile device software update management are disclosed. A described technique includes obtaining update information to modify a target function; identifying, from among a plurality of executing processes, a process that is operable to execute the target function, wherein the target function resides within a memory area associated with the identified process; suspending the identified process; determining, within the memory area, a memory address of the target function based on the obtained update information; modifying the target function in the memory area based on the memory address and the obtained update information to produce a modified function; and resuming the modified process.

### CROSS REFERENCE TO RELATED APPLICATION

This patent document claims the benefit of the priority of U.S. Provisional Application Ser. No. 61/739,640, filed Dec. 19, 2012 and entitled “PATCHLESS UPDATE MANAGEMENT ON MOBILE DEVICES,” which is incorporated herein by reference in its entirety.

### FIELD

This document generally relates to software update management.

### BACKGROUND

Mobile devices (e.g., smartphones, tablet computers and the like) typically are implemented as special purpose computers that are powered by a mobile operating system (“OS”). The most common mobile operating systems used by modern smartphones include Google's Android, Apple's iOS, Nokia's Symbian, RIM's BlackBerry OS, Samsung's Bada, Microsoft's Windows Phone, Hewlett-Packard's webOS, and embedded Linux distributions such as Maemo and MeeGo. Such operating systems can be installed on many different phone models. Further, a device can receive multiple OS software updates and application software updates over its lifetime. For example, software can be updated to fix security bugs, fix functionality issues, and/or add new features.

### SUMMARY

This document describes, among other things, technologies relating to mobile device software update management. In one aspect, a described technique includes obtaining update information to modify a target function; identifying, from among a plurality of executing processes, a process that is operable to execute the target function, where the target function resides within a memory area associated with the identified process; suspending the identified process; determining, within the memory area, a memory address of the target function based on the obtained update information; modifying the target function in the memory area based on the memory address and the obtained update information to produce a modified function; and resuming the modified process.

The above and other implementations can include one or more of the following features. Implementations can include allocating memory to store a patched version of the target function. Modifying the target function can include overwriting an original instruction with an instruction to change control flow to the patched version of the target function. Implementations can include allocating a segment in the memory area; including one or more instructions in the segment that are in accordance with the update information; and marking the segment as executable. Modifying the target function can include overwriting an original instruction with a new instruction to change control flow to the segment. Implementations can include including one or more instructions in the segment to compensate for overwriting the original instruction. Implementations can include detecting a start of a new process; determining whether the update information applies to the new process; and selectively applying the update information to the new process. The update information can include a sequence of bytes corresponding to at least a portion of the target function. Determining the location of the target function can include comparing the sequence of bytes with one or more portions of the memory area. Determining the location of the target function can include retrieving an address from a dynamic linking loader based on a symbol identifier that corresponds to the target function, the symbol identifier being included in the update information. Identifying the process can include accessing an application name indicated by the update information; obtaining a list of process information elements of respective processes that are in a executing state; and selecting a process from the list based on the application name. Identifying the process can include receiving a notification of a creation of a new process; and comparing an application name associated with the new process with an application name indicated by the update information. In some implementations, the memory area resides in a volatile random access memory structure within the mobile device. In some implementations, the update information can include a binary code segment, and modifying the target function can include writing the binary code segment to the volatile random access memory structure using the memory address.

A mobile device can include a receiver to receive information over a wireless channel, the information including update information that is formulated to modify a target function; and a processor configured to perform operations. The receiver can be included within a transceiver. The operations can include identifying, from among a plurality of executing processes, a process that is operable to execute the target function, where the target function resides within a memory area associated with the identified process; suspending the identified process; determining, within the memory area, a memory address of the target function based on the obtained update information; modifying the target function in the memory area based on the memory address and the obtained update information to produce a modified function; and resuming the modified process.

A system can include a network interface configured to communicate with mobile devices; and a server configured to send update information to the mobile devices such that, when received, the update information causes the mobile devices to perform operations that include extracting an identifier of a target function from the update information; identifying, from among a plurality of executing processes, a process that is operable to execute the target function, the target function residing within a memory area associated with the identified process; suspending the identified process; determining, within the memory area, a memory address of the target function based on the obtained update information; modifying the target function in the memory area based on the memory address and the obtained update information to produce a modified function; and resuming the modified process.

The above and other implementations can include one or more of the following features. The operations can include allocating memory to store a patched version of the target function. Modifying the target function can include overwriting an original instruction with an instruction to change control flow to the patched version of the target function. The operations can include allocating a segment in the memory area; including one or more instructions in the segment that are in accordance with the update information; and marking the segment as executable. Modifying the target function can include overwriting an original instruction with a new instruction to change control flow to the segment. The operations can include including one or more instructions in the segment to compensate for overwriting the original instruction. The operations can include detecting a start of a new process; determining whether the update information applies to the new process; and selectively applying the update information to the new process. The update information can include a sequence of bytes corresponding to at least a portion of the target function. Determining the location of the target function can include comparing the sequence of bytes with one or more portions of the memory area. Determining the location of the target function can include retrieving an address from a dynamic linking loader based on a symbol identifier that corresponds to the target function, the symbol identifier being included in the update information. Identifying the process can include accessing an application name indicated by the update information; obtaining a list of process information elements of respective processes that are in an executing state; and selecting a process from the list based on the application name. Identifying the process can include receiving a notification of a creation of a new process; and comparing an application name associated with the new process with an application name indicated b the update information. The memory area resides in a volatile random access memory structure within the mobile device. The update information can include a binary code segment. Modifying the target function can include writing the binary code segment to the volatile random access memory structure using the memory address.

Particular implementations of the technology described in this document may realize one or more of the following potential advantages. The techniques described here may be implemented to quickly distribute software updates to mobile devices, and have the software updates be applied with little or no impact to the mobile device user. Minimizing the time between detecting a software security bug and applying the corresponding update can decrease the window of opportunity to infect a mobile device with malware. Applying an update to a process without having to restart the process to benefit from the update can improve the user experience.

Details of one or more implementations of the subject matter described in this document are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1A shows a simplified architecture of an example of a system that includes an update server system and a mobile device that includes an update manager.

FIG. 1B shows a simplified architecture of an example of a mobile device that includes an update manager.

FIG. 1C shows a simplified architecture of an example of a mobile device with associated memory areas.

FIG. 2 shows a flowchart of an example of an update procedure performed by a mobile device's update manager.

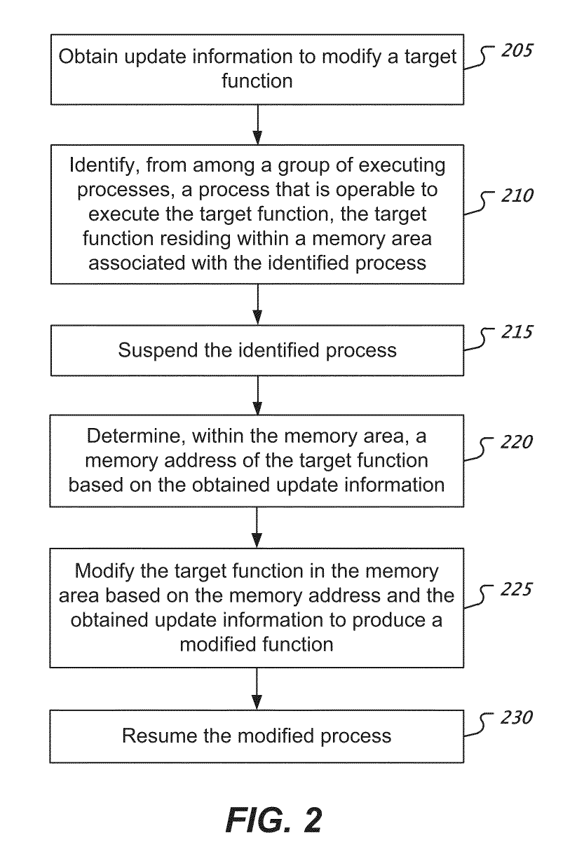

FIG. 3 shows a flowchart of another example of an update procedure performed by a mobile device's update manager.

FIG. 4 shows a layout of an example of a memory area that has been modified based on update information.

FIG. 5 shows a block diagram of computing devices that may be used to implement the systems and methods described in this document.

Like reference symbols in the various drawings indicate like elements.

### DETAILED DESCRIPTION

The typical software update process for mobile devices can be long and cumbersome. Generally speaking, software providers have to rebuild software and push it to mobile devices. Often, this requires a new software package to be distributed, rather than just a small corrective patch. For example, adding a check to guard against a buffer overflow attack may shift the addresses of a majority of symbols, including function addresses, within a corresponding binary image, and accordingly, a new binary image may have to be distributed. Downloading a replacement software package can consume substantial carrier bandwidth. Further, installing the package may take a considerable amount of time and may render the phone unusable for the duration of the install. Unfortunately, mobile device subscribers may delay installing updates because of these inconveniences. The cumulative delays of bug detection, software update generation, and user elected installations may leave mobile devices open to vulnerabilities longer than they ought to be. This disclosure provides, among other things, techniques, devices, and systems to update software without requiring a reboot or restart.

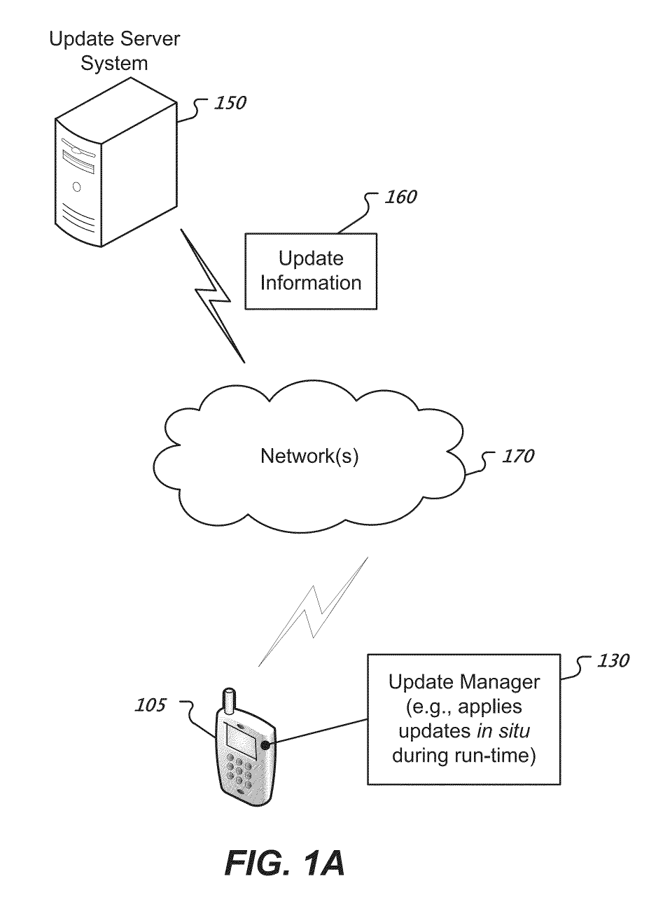

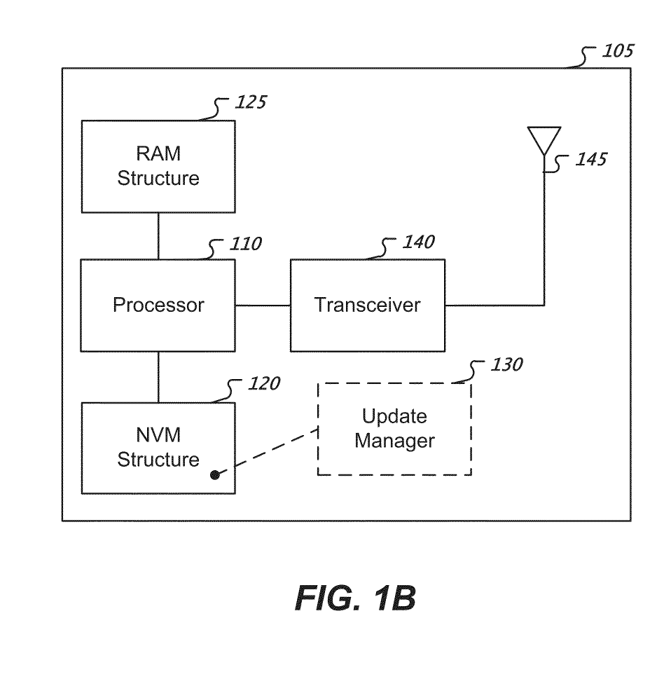

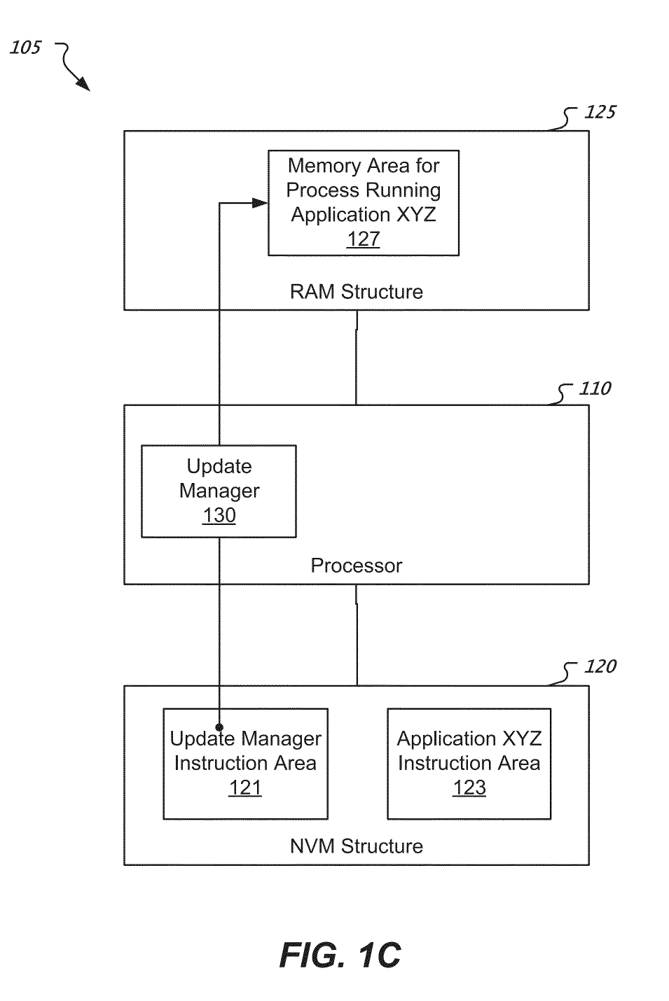

FIG. 1A shows a simplified architecture of an example of a system that includes an update server system 150 and a mobile device 105 that includes an update manager 130. A system can include an update server system 150 and a mobile device 105 that commnunicate via a network 121 which can include or couple with one or more wireless networks and wired networks, including the Internet. The mobile device 105 can be configured to execute an update manager 130. The update server system 150 can be configured to send update information 160 to the mobile devices such that, when received, the update information 160 causes the mobile devices to perform operations via the update manager 130. Further, the update information 160 can be formulated to enable the update manager 130 to apply an update in situ during run-time, e.g., apply an update to a dynamically allocated memory area for a process affected by the update to avoid re-launching the process or rebooting the device 105.

Update information 160 can include one or more software updates. A software update can, for example, include one or more security fixes, functionality fixes, functionality enhancements, functionality additions, or a combination thereof. Software updates can be distributed via one or more update server systems 150. An update manager 130 on the mobile device 105 can retrieve software updates from the update server system 150 and apply the updates. The update manager 130 can apply a software update during run-time such that a process executing the application can immediately benefit from the software update without having to be restarted.

FIG. 1B shows a simplified architecture of an example of a mobile device 105 that includes an update manager 130. The mobile device 105 includes a processor 110, a transceiver 140, an antenna 145, a non-volatile memory (NVM) structure 120, and a random-access memory (RAM) structure 125. The transceiver 140 can be configured to send and receive data over a wireless channel via the antenna 145. The transceiver 140 can include a receiver and a transmitter. The NVM structure 120 stores software such as a mobile device OS and application software. The processor 110 can load software from the NVM structure 120 into the RAM structure 125, and can start to execute the software from the RAM structure 125. In some implementations, the processor 110 directly executes software from the NVM structure 120. In some implementations, the processor 110 includes multiple processor cores. The RAM structure 125 can be volatile, meaning that the RAM structure 125 requires power to maintain stored data.

The mobile device 105 can send and receive data packets over one or more wireless interfaces. For example, the mobile de-vice's processor 110 can send and receive data packets via a transceiver 140 and an antenna 145. Various examples of wireless interface technology include interfaces based on Long Term Evolution (LTE), Global System for Mobile Communications (GSM), IEEE 802.11a/b/g/n/ac, and Code Division Multiple Access (CDMA) technologies such as CDMA2000 and WCDMA. Other types of wireless interface technologies are possible. In some implementations, the mobile device 105 can include multiple antennas 145, multiple transceivers 140, or both. The mobile device 105 can download application software over one or more of these wireless interfaces and store the application software on a memory structure such as the NVM structure 120, the RAM structure 125, or both.

The update manager 130 can apply one or more updates to functions that are included in an operating system image of the mobile device 105 without requiring a reboot. In some implementations, the update manager 130 can apply an update and later remove the update. For example, if the mobile device 105 connects to a corporate network which may require a higher level of security, the update can be applied. If the mobile device 105 disconnects from the corporate network, the update can be removed. In some implementations, the update manager 130 can apply an update for a configurable amount of time. The mobile device 105 can employ one or more exploit prevention mechanisms for added layers of protection. In some implementations, the update manager 130 is installed by a user. In some implementations, the update manager 130 is loaded into the device 105 during a manufacturing process.

FIG. 1C shows a simplified architecture of an example of a mobile device 105 with associated memory areas. The mobile device 105 includes a processor 110, NVM structure 120, and RAM structure 125. Instructions for an application can be stored within an instruction memory area 123 of the NVM structure 120. The processor 110 can create a process based on a launch of the application. Further, the processor 110 can allocate a memory area 127 for the process within the RAM structure 125. In some implementations, the memory area 127 includes an instruction memory area, a heap memory area, and a stack memory area. Rather than modifying the application's instruction memory area 123 in NVM structure 120, the update manager 130 can modify the process's memory area 127 in the RAM structure 125 for the application using update information 160 sent by the update server system 150. The processor 110 can execute the update manager 130 based on instructions stored in the update manager instruction area 121 of the NVM structure 120. Moreover, the update manager 130 can cause the processor 110 to overwrite one or more bytes within the process's memory area 127 in the RAM structure 125.

FIG, 2 shows a flowchart of an example of an update procedure performed by a mobile device's update manager. The update manager, at 205, obtains update information to modify a target function. Obtaining update information can include receiving one or more messages from an update server system via a wireless network connection. The update information can include one or more of the following: a name of a target function, a name of an application and/or library that uses the target function, information to locate a memory address of the target function, and code modification information. The code modification information can include one or more replacement instructions to overwrite one or more instructions starting at the memory address. In some cases, code modification information can include a new function and a replacement instruction, where the replacement instruction is intended to be placed within the target function to cause the target function to call the new function. The update information can include binary code that can be directly executed by a processor of the mobile device. Various examples of binary code include ARM, Thumb, x86, and Java bytecode. Other types of binary code are possible.

At 210, the update manager identifies, from among a group of executing processes, a process that is operable to execute the target function. The target function resides within a memory area associated with the identified process. Identifying the process can include accessing an application name indicated by the update information, obtaining a list of process information elements of respective processes that are in a executing state, and selecting a process from the list based on the application name. In some implementations, identifying the process can include receiving a notification of a creation of a new process, and comparing an application name associated with the new process with an application name indicated by the update information. In some implementations, a system call that creates a new process such as fork can be modified to generate a process creation notification.

At 215, the update manager suspends the identified process. At 220, the update manager determines, within the memory area, a memory address of the target function based on the obtained update information. In some implementations, update information includes a sequence of bytes corresponding to at least a portion of the target function, and determining the location of the target function includes comparing the sequence of bytes with one or more portions of the memory area until a match is found. In some implementations, update information includes a symbol identifier corresponding to the target function, and determining the location of the target function includes retrieving an address from a dynamic linking loader based on the symbol identifier.

At 225, the update manager modifies the target function in the memory area based on the memory address and the obtained update information to produce a modified function. In some implementations, the update manager can allocate memory within the memory area to store a patched version of the target function, and modifying the target function can include overwriting an original instruction of the target function with an instruction to change control flow to the patched version of the target function. At 230, the update manager resumes the modified process.

The mobile device OS can launch an application, for example, by creating a process, allocating a memory area in a memory structure of the mobile device, such as a volatile RAM structure, and loading the application's binary code into the memory area. Modifying the target function at 225 can include accessing a binary code segment from update information, and writing the binary code segment to a volatile RAM structure starting at the memory address determined at 220. An update manager can be configured to reapply the update after each reboot.

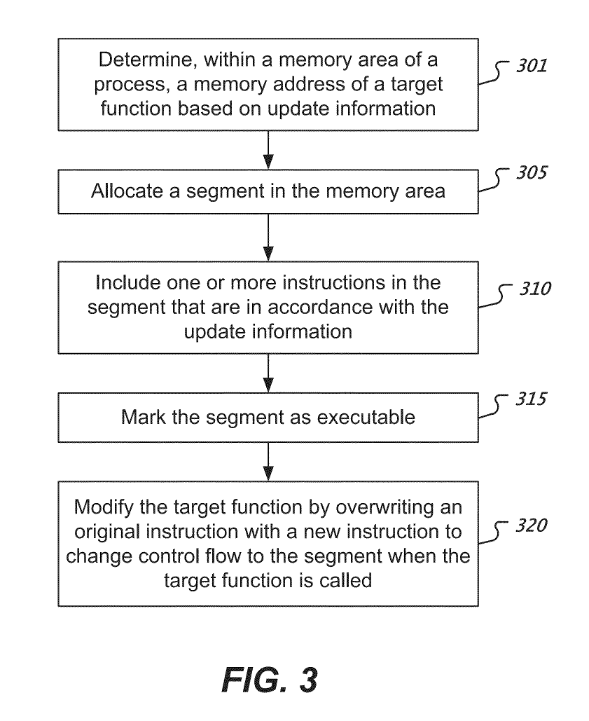

FIG. 3 shows a flowchart of another example of an update procedure performed by a mobile device's update manager. At 301, the update manager determines, within a memory area of a process, a memory address of a target function based on update information. At 305, the update manager allocates a segment in the memory area. At 310, the update manager includes one or more instructions in the segment that are in accordance with obtained update information. In some implementations, the update manager includes one or more instructions in the segment to compensate for overwriting the original instruction. At 315, the update manager marks the segment as executable. Marking the segment as executable can include setting an executable flag for a memory page containing the segment. At 320, the update manager modifies the target function by overwriting an original instruction with a new instruction to change control flow to the segment when the target function is called. Overwriting an original instruction can include inserting binary code that contains a binary representation of a control flow instruction such as a branch instruction or a jump instruction. Other types of control flow instructions are possible.

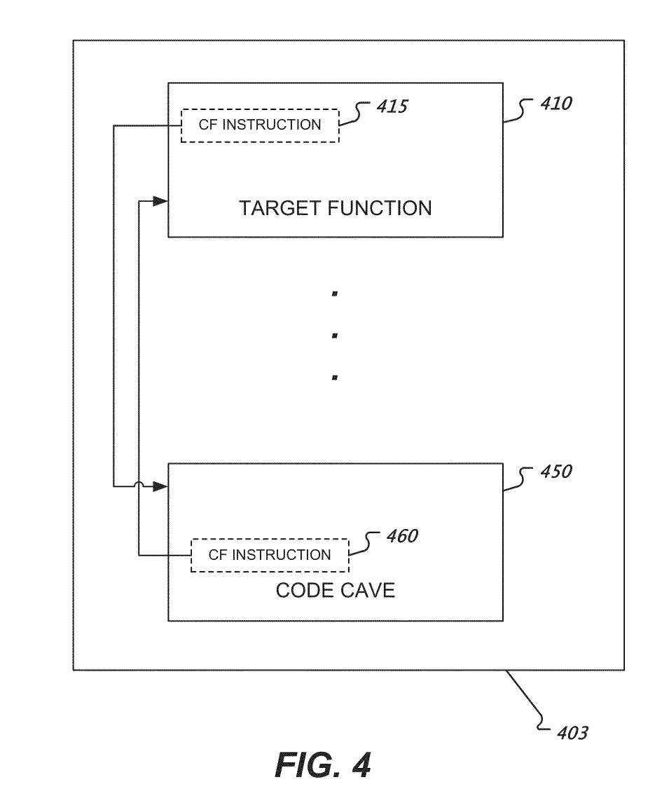

FIG. 4 shows a layout of an example of a memory area 403 that has been modified based on update information. An update manager modifies the memory area 403 to include a segment which, for this example, has been labeled as a code cave 450. The update manager modifies a target function 410 to include a control flow instruction 415 that changes control flow to the code cave 450 when the target function 410 is called. In some implementations, the code cave 450 includes a control flow instruction 460 that returns control flow back to a subsequent instruction within the target function 410.

After identifying a process for updating, an update manager suspends and accesses the process by using a root privilege. In some implementations, the update manager uses a system call such as ptrace to suspend and access the process. The update manager can be configured to locate a target function within a memory area of the process by using a memory location technique, in some implementations, a memory location technique includes retrieving a pattern identifier specified by update information, searching a memory area for the corresponding pattern, and returning a start address of the corresponding pattern located within the memory area. Various examples of pattern identifiers include a byte sequence or a regular expression (“regex”). Other types of pattern identifiers are possible. Searching a memory area for the corresponding pattern can include iteratively comparing a byte sequence with different portions of a memory area until a matching portion is located. In some implementations, the update manager can use a technique based on Hash-AV for scanning and/or matching (Ozgun Erdogan and Pei Cao, “Hash-AV: Fast Virus Signature Scanning by Cache-Resident Filters,” Department of Computer Science, Stanford University).

In some implementations, a memory location technique includes retrieving a target function symbol identifier from update information and using a library programming interface such as dIsym to locate the corresponding target function within the library. A target function symbol identifier can include a text string, which can specify a name of the target function. In some implementations, a memory location technique includes locating a name of function within a symbol table. The update manager can overwrite one or more instructions within the target function with one or more replacement instructions. In some implementations, a replacement instruction can fix a mistake in an original instruction. However, if additional instructions are required to make the fix, a replacement instruction can be a control flow instruction that changes control flow to a code cave. The update manager can find unallocated space within the memory area for allocating room to create the code cave. In some implementations, the update manager locates a sequence of bytes in a binary not being used in the slack space of the page aligned memory of the process. The update manager makes the code cave memory executable, for example, by using mprotect. The update manager can inject one or more code blocks into the code cave. Injected code blocks can include a block that saves registers as they would be in the current target function, a block that contains logic to patch the functionality of the target function, a block that restores a register state the way that it was, a block that includes one or more instructions that compensate for the one or more overwritten instructions within the target function, and a block that returns execution to the instruction immediately following the one or more replacement instructions within the target function. Once updated, the update manager can resume the process.

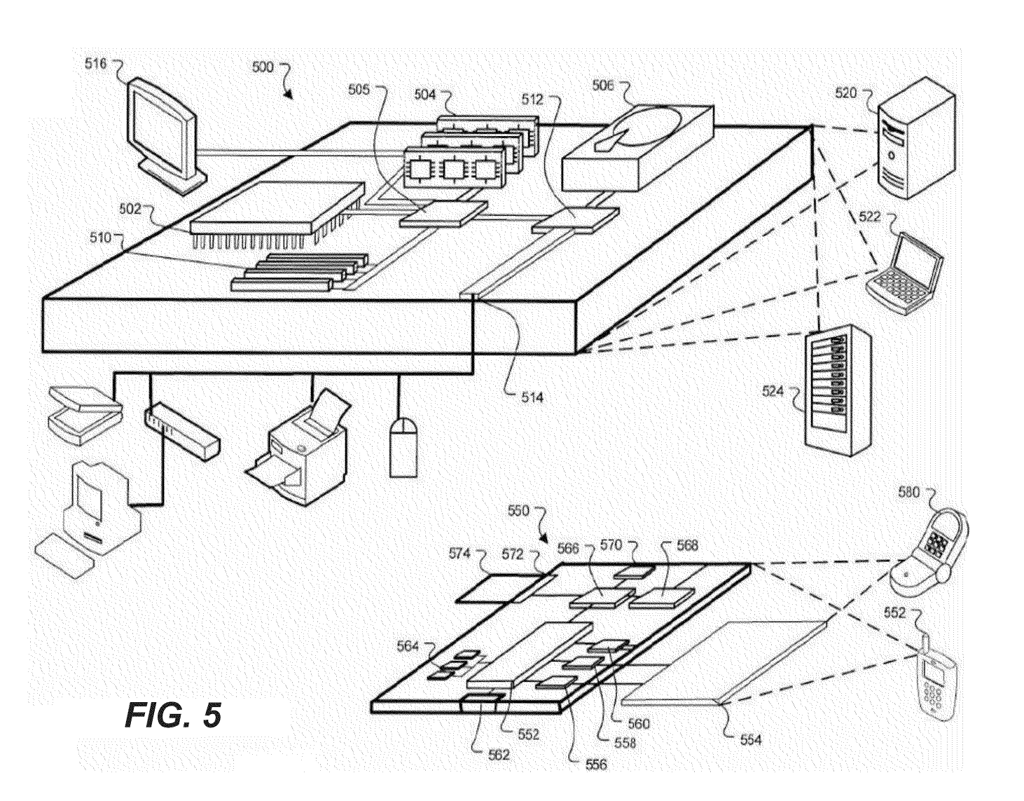

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers and/or mobile devices. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information Dora GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other,

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network), Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by a mobile device, the method comprising:
obtaining update information to modify a target function;
identifying, from among a plurality of executing processes, a process that is operable to execute the target function, wherein the target function resides within a memory area associated with the identified process;
suspending the identified process;
determining, within the memory area, a memory address of the target function based on the obtained update information;
modifying the target function in the memory area based on the memory address and the obtained update information to produce a modified function; and
resuming the modified process.

2. The method of claim 1, comprising:
allocating memory to store a patched version of the target function, wherein modifying the target function comprises overwriting an original instruction with an instruction to change control flow to the patched version of the target function.

3. The method of claim 1, comprising:
allocating a segment in the memory area;
including one or more instructions in the segment that are in accordance with the update information; and
marking the segment as executable,
wherein modifying the target function comprises overwriting an original instruction with a new instruction to change control flow to the segment.

4. The method of claim 3, comprising:
including one or more instructions in the segment to compensate for overwriting the original instruction.

5. The method of claim 1, comprising:
detecting a start of a new process;
determining whether the update information applies to the new process; and
selectively applying the update information to the new process.

6. The method of claim 1, wherein the update information comprises a sequence of bytes corresponding to at least a portion of the target function, and wherein determining the location of the target function comprises comparing the sequence of bytes with one or more portions of the memory area.

7. The method of claim 1, wherein determining the location of the target function comprises retrieving an address from a dynamic linking loader based on a symbol identifier that corresponds to the target function, the symbol identifier being included in the update information.

8. The method of claim 1, wherein identifying the process comprises:
accessing an application name indicated by the update information;
obtaining a list of process information elements of respective processes that are in a executing state; and
selecting a process from the list based on the application name.

9. The method of claim 1, wherein identifying the process comprises:
receiving a notification of a creation of a new process; and
comparing an application name associated with the new process with an application name indicated by the update information.

10. The method of claim 1, wherein the memory area resides in a volatile random access memory structure within the mobile device.

11. The method of claim 10, wherein the update information includes a binary code segment, and wherein modifying the target function comprises writing the binary code segment to the volatile random access memory structure using the memory address.

11. A mobile device comprising:
a receiver configured to receive information over a wireless channel, the information including update information that is formulated to modify a target function; and
a processor configured to perform operations comprising:
identifying, from among a plurality of executing processes, a process that is operable to execute the target function, wherein the target function resides within a memory area associated with the identified process;
suspending the identified process;
determining, within the memory area, a memory address of the target function based on the Obtained update information;
modifying the target function in the memory area based on the memory address and the obtained update information to produce a modified function; and
resuming the modified process.

12. The device of claim 11, wherein the operations comprise:
allocating memory to store a patched version of the target function, wherein modifying the target function comprises overwriting an original instruction with an instruction to change control flow to the patched version of the target function.

13. The device of claim 11, wherein the operations comprise:
allocating a segment in the memory area;
including one or more instructions in the segment that are in accordance with the update information; and
marking the segment as executable,
wherein modifying the target function comprises overwriting an original instruction with a new instruction to change control flow to the segment.

14. The device of claim 13, wherein the operations comprise:
including one or more instructions in the segment to compensate for overwriting the original instruction.

15. The device of claim 11, wherein the operations comprise:
detecting a start of a new process;
determining whether the update information applies to the new process; and
selectively applying the update information to the new process.

16. The device of claim 11, wherein the update information comprises a sequence of bytes corresponding to at least a portion of the target function, and wherein determining the location of the target function comprises comparing the sequence of bytes with one or more portions of the memory area.

17. The device of claim 11, wherein determining the location of the target function comprises retrieving an address from a dynamic linking loader based on a symbol identifier that corresponds to the target function, the symbol identifier being included in the update information.

18. The device of claim 11, wherein identifying the process comprises:
accessing an application name indicated by the update information;
obtaining a list of process information elements of respective processes that are in a executing state; and
selecting a process from the list based on the application name.

19. The device of claim 11, wherein identifying the process comprises:
receiving a notification of a creation of a new process; and
comparing an application name associated with the new process with an application name indicated by the update information.

20. The device of claim 11, wherein the memory area resides in a volatile random access memory structure within the mobile device.

21. The device of claim 20, wherein the update information includes a binary code segment, and wherein modifying the target function comprises writing the binary code segment to the volatile random access memory structure using the memory address.

22. A system comprising:
a network interface configured to communicate with mobile devices; and
a server configured to send update information to the mobile devices such that, when received, the update information causes the mobile devices to perform operations comprising:
extracting an identifier of a target function from the update information;
identifying, from among a plurality of executing processes, a process that is operable to execute the target function, wherein the target function resides within a memory area associated with the identified process;
suspending the identified process;
determining, within the memory area, a memory address of the target function based on the obtained update information;
modifying the target function in the memory area based on the memory address and the obtained update information to produce a modified function; and
resuming the modified process.

23. The system of claim 22, wherein the update information comprises a sequence of bytes corresponding to at least a portion of the target function, and wherein determining the location of the target function comprises comparing the sequence of bytes with one or more portions of the memory area.

24. The system of claim 22, wherein determining the location of the target function comprises retrieving an address from a dynamic linking loader based on a symbol identifier that corresponds to the target function, the symbol identifier being included in the update information.
